(19) United States
(12) Patent Application Publication
(10) Pub. No.: US 2023/0289704 A1
(43) Pub. Date: Sep. 14, 2023

(54) AUTOMATIC CREATION OF DATA MODELS BASED ON SEMANTIC UNDERSTANDING

(71) Applicant: UiPath, Inc., New York, NY (US)

(72) Inventors: Palak KADAKIA, Redmond, WA (US); Matthew VANDERZEE, Sammamish, WA (US); Ankit SARAF, Bellevue, WA (US); Paramjit Singh KAHLON, Clyde Hill, WA (US)

(73) Assignee: UiPath, Inc., New York, NY (US)

(21) Appl. No.: 17/654,800

(22) Filed: Mar. 14, 2022

(51) Int. Cl. G06Q 10/06; G06F 16/26

(52) U.S. Cl. CPC G06Q 10/067; G06F 16/26

(57) ABSTRACT

Systems and methods for automatically creating a data model are provided. A semantic understanding of entities stored in one or more business data sources is determined. The entities are extracted from the one or more business data sources based on the semantic understanding. A data model for the entities is created. The data model is output.

### TECHNICAL FIELD

The present invention relates generally to automatic creation of data models, and more particularly to automatic creation of data models based on semantic understanding.

### BACKGROUND

A data model is a model that organizes entities and standardizes how the entities relate to one another. Conventionally, data models are manually created by users. However, such conventional creation of data models is a tedious and labor-intensive process.

### BRIEF SUMMARY OF THE INVENTION

In accordance with one or more embodiments, systems and methods for automatically creating a data model are provided. A semantic understanding of entities stored in one or more business data sources is determined. The entities are extracted from the one or more business data sources based on the semantic understanding. A data model for the entities is created. The data model is output.

In one embodiment, the semantic understanding of the entities is determined based on at least one of task mining data or process mining data defining interactions between the entities and users. In another embodiment, the semantic understanding of the entities is determined based on robot execution data defining interactions between the entities and robots. The robot execution data may comprise data relating to execution of an RPA (robotic process automation) process by one or more RPA robots. In one embodiment, standardized fields for the data model are defined based on at least one of the task mining data, the process mining data, or the robot execution data.

In one embodiment, the data model is stored with the semantic understanding in storage. In another embodiment, the data model is presented on a display device as a work graph.

These and other advantages of the invention will be apparent to those of ordinary skill in the art by reference to the following detailed description and the accompanying drawings.

### BRIEF DESCRIPTION OF THE DRAWINGS

FIG. 1 shows a method for automatically creating a data model, in accordance with one or more embodiments; and

FIG. 2 is a block diagram of a computing system according to an embodiment of the invention.

### DETAILED DESCRIPTION

Embodiments described herein provide for the automatic creation of data models based on semantic understanding. A data model is a model that organizes entities and standardizes how the entities relate to one another. Advantageously, embodiments described herein determine a semantic understanding of entities stored in one or more business data sources to enable extraction of the entities from the business data sources and creation of a data model of the entities.

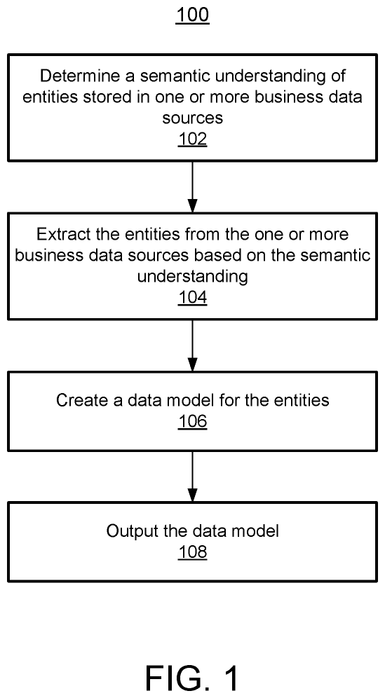

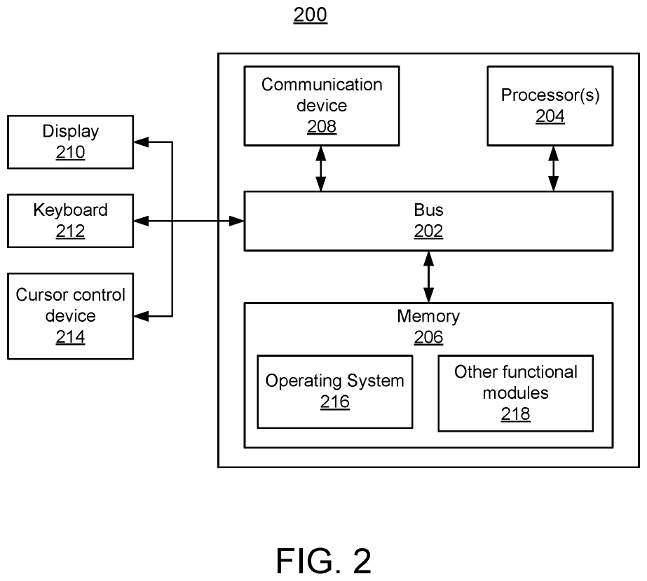

FIG. 1 shows a method 100 for automatically creating a data model, in accordance with one or more embodiments. The steps of method 100 may be performed by any suitable computing device, such as, e.g., computing system 200 of FIG. 2.

At step 102, a semantic understanding of entities stored in one or more business data sources is determined. The one or more business data sources may comprise any suitable data source, such as, e.g., databases, CV (computer vision), DU (document understanding), images, user (e.g., expert or practitioner) provided inputs (e.g., process diagrams or task captures), robot (e.g., RPA (robotic process automation) robot) logs, robot process definition files, etc. In one example, the one or more business data sources comprise an SAP (systems, applications, and products) database. The entities may comprise any data element of the business data sources, such as, e.g., purchase orders, cases, patients, suppliers, products, etc. and their records.

The semantic understanding describes an interpretation of the underlying system's data. The semantic understanding may comprise a mapping of data entities to a higher-level, human-understandable data model. The semantic understanding may also comprise a mapping of data entities to common terms and concepts for a given process space or industry. For example, in payment processes, common entities include Invoices, Vendors, and Payments. The semantic understanding of the underlying system data would include a mapping of the system data to a data model that includes these common entities.

In one embodiment, this semantic understanding is determined by automatically mapping system data to the common data entities. In one example, the mapping is performed by relating labels and metadata of the system data to common labels and metadata in industry standard entities. In another example, the mapping is performed by pattern matching. In a further example, the mapping is performed by comparing the system data's entities and entity connectivity to common process- or industry-specific entities and entity connectivity. For example, for a purchasing process, the system data may comprise an entity that is involved with multiple invoices, whose metadata includes a Tax ID number. The system will use these and other contextual clues to map this entity to a Vendor.

In another embodiment, semantic understanding is determined via task mining data. As used herein, task mining refers to the automatic identification of tasks (e.g., manual repetitive tasks) by observing (e.g., real time or near real time monitoring or offline analysis) user interaction (e.g., explicit user input or inferred user activity) on applications. The task mining data defines interactions between the entities and users. Because the business data sources include execution information from the users who are participating in the process, it comprises a variety of contextual information that can help build a semantic data model. For example, if an individual is working on a purchasing process and is responsible for approving an invoice, the individual will at various points in the process be presented with invoice data. That visualization of the data will include UI (user interface) labels that make sense to the individual. These labels can provide contextual clues as to what the data being presented actually represents. Extracting this UI context and connecting it to the underlying data allows the system to automatically define the data model's entities in a semantically correct way.

The semantic understanding may be determined using any other suitable discovery technique. For example, the semantic understanding may be determined from process mining data or robot execution data. The robot execution data defines interactions between the entities and robots. In one embodiment, the robot execution data is data relating to the execution of an RPA process executed by one or more RPA robots.

At step 104, the entities are extracted from the one or more business data sources based on the semantic understanding. In one embodiment, the entities may be extracted from the one or more business data sources by matching names and attributes of tables or columns. In another embodiment, the entities may be extracted from the one or more business data sources by matching data in the one or more business data sources with known patterns. For example, if a certain entity goes through the states Open to Waiting for Support to Waiting for Customer to Resolved, it is highly likely that the pattern of states corresponds to a support case.

At step 106, a data model for the entities is created. The data model organizes the entities and standardizes how the entities relate to one another based on the semantic understanding. For example, the data model may comprise standardized fields defining various properties, metadata, etc. of the entities determined from the task mining data, process mining data, or the robot execution data. The data model is created by interrelating the entities according to the fields using the semantic understanding.

In one embodiment, the semantic understanding (e.g., process mining data, task mining data, and/or robot execution data) is used to identify new fields, properties, metadata, etc. for the data model that may not have been previously available in the one or more business data sources. Because humans and/or robots are executing the processes, their interfaces (e.g., the user interface and robot execution interface, respectively) provide insight to these missing properties and metadata. For example, in a purchasing process, an invoice approver may treat some vendors' invoices differently than others because of preexisting knowledge of those vendors (e.g., their payment methods differ or their invoices require special scrutiny or they have preferred treatment). This context isn't present in the underlying system data but is an important influence on the purchasing process. By leveraging task mining, process mining, and robot execution data, this metadata can be identified and factored into the data model.

At step 108, the data model is output. For example, the data model may be output by displaying the data model on a display device of a computer system, storing the data model on a memory or storage of a computer system, or by transmitting the data model to a remote computer system. In one embodiment, the data model is displayed to the user as a work graph. In another embodiment, the data model may be visualized as a form or a user interface. The semantic understanding may be stored along with the data model.

In one exemplary application, method 100 may be applied for an order-to-cash process of an organization. A semantic understanding of the order-to-cash process can be determined. The semantic understanding may comprise metadata of the process, such as, e.g., customer contact, partners involved, order line items, etc. Order entities may be extracted from a business data source that have a semantic understanding that matches the order management process of the organization. A data model may be created for the order entities and displayed to a user as a work graph.

FIG. 2 is a block diagram illustrating a computing system 200 configured to execute the methods, workflows, and processes described herein, including method 100 of FIG. 1, according to an embodiment of the present invention. In some embodiments, computing system 200 may be one or more of the computing systems depicted and/or described herein. Computing system 200 includes a bus 202 or other communication mechanism for communicating information, and processor(s) 204 coupled to bus 202 for processing information. Processor(s) 204 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 204 may also have multiple processing cores, and at least some of the cores may be configured to perform specific functions. Multi-parallel processing may be used in some embodiments.

Computing system 200 further includes a memory 206 for storing information and instructions to be executed by processor(s) 204. Memory 206 can be comprised of any combination of Random Access Memory (RAM), Read Only Memory (ROM), flash memory, cache, static storage such as a magnetic or optical disk, or any other types of non-transitory computer-readable media or combinations thereof. Non-transitory computer-readable media may be any available media that can be accessed by processor(s) 204 and may include volatile media, non-volatile media, or both. The media may also be removable, non-removable, or both.

Additionally, computing system 200 includes a communication device 208, such as a transceiver, to provide access to a communications network via a wireless and/or wired connection according to any currently existing or future-implemented communications standard and/or protocol.

Processor(s) 204 are further coupled via bus 202 to a display 210 that is suitable for displaying information to a user. Display 210 may also be configured as a touch display and/or any suitable haptic I/O (input/output) device.

A keyboard 212 and a cursor control device 214, such as a computer mouse, a touchpad, etc., are further coupled to bus 202 to enable a user to interface with computing system. However, in certain embodiments, a physical keyboard and mouse may not be present, and the user may interact with the device solely through display 210 and/or a touchpad (not shown). Any type and combination of input devices may be used as a matter of design choice. In certain embodiments, no physical input device and/or display is present. For instance, the user may interact with computing system 200 remotely via another computing system in communication therewith, or computing system 200 may operate autonomously.

Memory 206 stores software modules that provide functionality when executed by processor(s) 204. The modules include an operating system 216 for computing system 200 and one or more additional functional modules 218 configured to perform all or part of the processes described herein or derivatives thereof.

One skilled in the art will appreciate that a “system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like. A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention. Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The foregoing merely illustrates the principles of the disclosure. It will thus be appreciated that those skilled in the art will be able to devise various arrangements that, although not explicitly described or shown herein, embody the principles of the disclosure and are included within its spirit and scope. Furthermore, all examples and conditional language recited herein are principally intended to be only for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future.

What is claimed is:

1. A computer-implemented method comprising:
determining a semantic understanding of entities stored in one or more business data sources;
extracting the entities from the one or more business data sources based on the semantic understanding;
creating a data model for the entities; and
outputting the data model.

2. The computer-implemented method of claim 1, wherein determining a semantic understanding of entities stored in one or more business data sources comprises:
determining the semantic understanding of the entities based on at least one of task mining data or process mining data defining interactions between the entities and users.

3. The computer-implemented method of claim 1, wherein determining a semantic understanding of entities stored in one or more business data sources comprises:
determining the semantic understanding of the entities based on robot execution data defining interactions between the entities and robots.

4. The computer-implemented method of claim 3, wherein the robot execution data comprises data relating to execution of an RPA (robotic process automation) process by one or more RPA robots.

5. The computer-implemented method of claim 1, wherein creating a data model for the entities comprises:
defining standardized fields for the data model based on at least one of task mining data, process mining data, or robot execution data.

6. The computer-implemented method of claim 1, wherein outputting the data model comprises:
storing the data model with the semantic understanding in storage.

7. The computer-implemented method of claim 1, wherein outputting the data model comprises:
presenting the data model on a display device as a work graph.

8. An apparatus comprising:
a memory storing computer instructions; and
at least one processor configured to execute the computer instructions, the computer instructions configured to cause the at least one processor to perform operations of:
determining a semantic understanding of entities stored in one or more business data sources;
extracting the entities from the one or more business data sources based on the semantic understanding;
creating a data model for the entities; and
outputting the data model.

9. The apparatus of claim 8, wherein determining a semantic understanding of entities stored in one or more business data sources comprises:
determining the semantic understanding of the entities based on at least one of task mining data or process mining data defining interactions between the entities and users.

10. The apparatus of claim 8, wherein determining a semantic understanding of entities stored in one or more business data sources comprises:
determining the semantic understanding of the entities based on robot execution data defining interactions between the entities and robots.

11. The apparatus of claim 10, wherein the robot execution data comprises data relating to execution of an RPA (robotic process automation) process by one or more RPA robots.

12. The apparatus of claim 8, wherein creating a data model for the entities comprises:
defining standardized fields for the data model based on at least one of task mining data, process mining data, or robot execution data.

13. The apparatus of claim 8, wherein outputting the data model comprises:
storing the data model with the semantic understanding in storage.

14. The apparatus of claim 8, wherein outputting the data model comprises:
presenting the data model on a display device as a work graph.

15. A non-transitory computer-readable medium storing computer program instructions, the computer program instructions, when executed on at least one processor, cause the at least one processor to perform operations comprising:
determining a semantic understanding of entities stored in one or more business data sources;
extracting the entities from the one or more business data sources based on the semantic understanding;
creating a data model for the entities; and
outputting the data model.

16. The non-transitory computer-readable medium of claim 15, wherein determining a semantic understanding of entities stored in one or more business data sources comprises:
determining the semantic understanding of the entities based on at least one of task mining data or process mining data defining interactions between the entities and users.

17. The non-transitory computer-readable medium of claim 15, wherein determining a semantic understanding of entities stored in one or more business data sources comprises:
determining the semantic understanding of the entities based on robot execution data defining interactions between the entities and robots.

18. The non-transitory computer-readable medium of claim 17, wherein the robot execution data comprises data relating to execution of an RPA (robotic process automation) process by one or more RPA robots.

19. The non-transitory computer-readable medium of claim 15, wherein creating a data model for the entities comprises:
defining standardized fields for the data model based on at least one of task mining data, process mining data, or robot execution data.

20. The non-transitory computer-readable medium of claim 15, wherein outputting the data model comprises:
storing the data model with the semantic understanding in storage.

21. The non-transitory computer-readable medium of claim 15, wherein outputting the data model comprises:
presenting the data model on a display device as a work graph.
